(19) United States
(12) Patent Application Publication
(10) Pub. No.: US 2020/0055998 A1
(43) Pub. Date: Feb. 20, 2020

(54) MASTERBATCH MANUFACTURING METHOD, RUBBER COMPOSITION MANUFACTURING METHOD, AND TIRE MANUFACTURING METHOD

(71) Applicant: TOYO TIRE CORPORATION, Itami-shi, Hyogo (JP)

(72) Inventor: Kenji Nomura, Itami-shi (JP)

(73) Assignee: TOYO TIRE CORPORATION, Itami-shi, Hyogo (JP)

(21) Appl. No.: 16/347,067

(22) PCT Filed: Jul. 10, 2017
(86) PCT No.: PCT/JP2017/025162

§ 371 Date: May 2, 2019

(30) Foreign Application Priority Data
Dec. 14, 2016 (JP) 2016-242484

(51) Int. Cl. C08J 3/22; C08J 3/205; C08K 3/04; C08K 5/00; B60C 1/00

(52) U.S. Cl. CPC C08J 3/226; C08J 3/205; C08J 2307/02; C08K 5/0025; B60C 1/00; C08K 3/04

(57) ABSTRACT

A masterbatch manufacturing method in accordance with the present disclosure comprises a first operation in which a pre-coagulation rubber latex comprising carbon black is heated as it is agitated with an agitator provided with agitator vane(s); and a second operation in which coagulant is added to the pre-coagulation rubber latex; wherein the first operation satisfies Formula I and Formula II. The Formula I is b≥i×5.6/100. The Formula II is b×tₘ/eₕ×100>10. b indicates agitator vane circumferential speed (m/s). i indicates iodine absorption (g/kg) of carbon black. tₘ indicates agitation time (s). eₕ is given by Formula III. The Formula III is eₕ=(tₑ+tₛ)×tₘ/2. tₑ indicates the temperature (° C.) of the pre-coagulation rubber latex at the end of the first operation. tₛ indicates the temperature (° C.) of the pre-coagulation rubber latex at the start of the first operation.

### TECHNICAL FIELD

The present disclosure relates to a masterbatch manufacturing method, rubber composition manufacturing method, and tire manufacturing method.

### BACKGROUND ART

Manufacture of wet masterbatch might, for example, encompass a procedure in which a carbon black slurry is added to natural rubber latex, this is agitated as it is heated, and coagulant is added thereto to collect a coagulum. Agitation and heating encourage gradual occurrence of coagulation.

In the context of such a procedure, it is difficult to cause carbon black of small particle diameter to be dispersed within natural rubber latex to the same extent as carbon black of medium particle diameter or large particle diameter. This is because the smaller the primary particle diameter of carbon black the poorer will be the dispersion characteristics thereof.

Poor dispersion of carbon black in natural rubber latex leads to poor dispersion of carbon black in masterbatch. Moreover, this also leads to worsening of fatigue resistance and heat generation in the vulcanized rubber.

### PRIOR ART REFERENCES

### Patent References

PATENT REFERENCE NO. 1: Japanese Patent Application Publication Kokai No. 2006-213866
PATENT REFERENCE NO. 2: Japanese Patent Application Publication Kokai No. 2007-237456
PATENT REFERENCE NO. 3: Japanese Patent Application Publication Kokai No. 2010-284799
PATENT REFERENCE NO. 4: Japanese Patent Application Publication Kokai No. 2016-14086

### SUMMARY OF INVENTION

### Means for Solving Problem

A masterbatch manufacturing method in accordance with the present disclosure comprises a first operation in which a pre-coagulation rubber latex comprising carbon black is heated as it is agitated with an agitator provided with agitator vane(s); and a second operation in which coagulant is added to the pre-coagulation rubber latex; wherein the first operation satisfies Formula I and Formula II.

b≥i×5.6/100 FORMULA I

b×tₘ/eₕ×100>10 FORMULA II

b indicates agitator vane circumferential speed (m/s). i indicates iodine absorption (g/kg) of carbon black. tₘ indicates agitation time (s). eₕ is given by Formula III.

eₕ=(tₑ+tₛ)×tₘ/2 FORMULA III

tₑ indicates the temperature (° C.) of the pre-coagulation rubber latex at the end of the first operation. tₛ indicates the temperature (° C.) of the pre-coagulation rubber latex at the start of the first operation.

### BRIEF DESCRIPTION OF DRAWINGS

FIG. 1 Schematic sectional diagram of agitator used in first embodiment.

### EMBODIMENTS FOR CARRYING OUT INVENTION

The present disclosure provides a method for manufacturing masterbatch for which dispersion of carbon black is excellent and which has excellent fatigue resistance and/or heat generation in vulcanized rubber.

A masterbatch manufacturing method in accordance with the present disclosure comprises a first operation in which a pre-coagulation rubber latex comprising carbon black is heated as it is agitated with an agitator provided with agitator vane(s); and a second operation in which coagulant is added to the pre-coagulation rubber latex; wherein the first operation satisfies Formula I and Formula II.

b≥i×5.6/100 FORMULA I

b×tₘ/eₕ×100>10 FORMULA II

b indicates agitator vane circumferential speed (m/s). i indicates iodine absorption (g/kg) of carbon black. tₘ indicates agitation time (s). eₕ is given by Formula III.

eₕ=(tₑ+tₛ)×tₘ/2 FORMULA III

tₑ indicates the temperature (° C.) of the pre-coagulation rubber latex at the end of the first operation. tₛ indicates the temperature (° C.) of the pre-coagulation rubber latex at the start of the first operation.

A masterbatch manufacturing method in accordance with the present disclosure permits manufacture of a masterbatch for which dispersion of carbon black is excellent and which has excellent fatigue resistance and/or heat generation in vulcanized rubber. This is because, since the first operation satisfies Formula I, it is possible to cause carbon black to be dispersed regardless of the particle diameter thereof, and because, since it satisfies Formula II, it is possible to suppress occurrence of a situation in which coagulant causes coagulation to occur while carbon black is still inadequately dispersed.

Because it satisfies Formula I, a masterbatch manufacturing method in accordance with the present disclosure is capable of causing carbon black to be dispersed regardless of the particle diameter thereof. This is because Formula I links circumferential speed to iodine absorption in such fashion as to cause agitator vane circumferential speed to increase as iodine absorption of carbon black increases.

Because it satisfies Formula II, a masterbatch manufacturing method in accordance with the present disclosure is capable of suppressing occurrence of a situation in which coagulant causes coagulation to occur while carbon black is still inadequately dispersed. The reason for this will now be explained. At Formula II, because b×tₘ corresponds to the amount of agitator vane rotation (m), and eₕ corresponds to the thermal energy input to the pre-coagulation rubber latex as a result of heating, Formula II ensures that there will be a certain fractional amount of agitator vane rotation, and limits the fractional thermal energy. A masterbatch manufacturing method in accordance with the present disclosure is therefore capable of encouraging coagulation due to agitation while appropriately limiting promotion of coagulation due to heating, and is capable of suppressing occurrence of a situation in which coagulant causes coagulation to occur while carbon black is still inadequately dispersed.

It is preferred that iodine absorption of carbon black be not less than 100 g/kg. Where this is not less than 100 g/kg, there will be increased significance to Formula I and/or Formula II.

A rubber composition manufacturing method in accordance with the present disclosure comprises the masterbatch manufacturing method in accordance with the present disclosure.

A tire manufacturing method in accordance with the present disclosure comprises the masterbatch manufacturing method in accordance with the present disclosure.

### Embodiment 1

The present disclosure will now be described in terms of a first embodiment.

A masterbatch manufacturing method in accordance with a first embodiment comprises an operation in which carbon black and rubber latex are mixed to obtain a carbon black slurry. Mixing the carbon black and the rubber latex makes it is possible to prevent reflocculation of carbon black. This is thought to be due to formation of an extremely thin latex phase on all or part of the surface of the carbon black, the latex phase inhibiting reflocculation of carbon black. It is preferred that iodine absorption of the carbon black be not less than 100 g/kg. As the upper limit of the range in values for the iodine absorption of the carbon black, 170 g/kg, 160 g/kg, and so forth may be cited as examples. Iodine absorption of carbon black is measured in accordance with ASTM D1510. The rubber latex at the operation in which the carbon black slurry is made might, for example, be natural rubber latex, synthetic rubber latex, and/or the like. The number average molecular weight of natural rubber within the natural rubber latex might, for example, be not less than 2,000,000. As the natural rubber latex, latex concentrate, fresh latex such as that which is referred to as “field latex,” or any other such latex may be used without distinction. The synthetic rubber latex might, for example, be styrene-butadiene rubber latex, butadiene rubber latex, nitrile rubber latex, and/or chloroprene rubber latex. It is preferred that solids (rubber) concentration in the rubber latex be not less than 0.1 mass %, more preferred that this be not less than 0.2 mass %, and still more preferred that this be not less than 0.3 mass %. The upper limit of the range in values for the solids concentration might, for example, be 5 mass %, it being preferred that this be 2 mass %, and it being more preferred that this be 1 mass %. The carbon black and the rubber latex may be mixed using a high-shear mixer, high shear mixer, homomixer, ball mill, bead mill, high-pressure homogenizer, ultrasonic homogenizer, colloid mill, and/or other such ordinary disperser. “High-shear mixer” refers to a mixer which is provided with rotor(s) and stator(s) and in which there is action of high shear due to rotation of rotor(s) under conditions in which there is precise clearance between stationary stator(s) and rotor(s) capable of rotating at high speed. To cause action of such high shear, it is preferred that clearance between rotor and stator be not greater than 0.8 mm and that rotor circumferential speed be not less than 5 m/s. As such high-shear mixer, commercially available devices may be employed, it being possible to cite high shear mixers manufactured by the Silverson company as examples.

In the carbon black slurry, carbon black is dispersed in water. It is preferred that the amount of carbon black in the carbon black slurry be not less than 1 mass %, and more preferred that this be not less than 3 mass %, per 100 mass % of the carbon black slurry. It is preferred that the upper limit of the range in values for the amount of carbon black in the carbon black slurry be 15 mass %, and more preferred that this be 10 mass %.

A masterbatch manufacturing method in accordance with the first embodiment further comprises an operation in which the carbon black slurry and rubber latex are mixed to obtain a pre-coagulation rubber latex. The rubber latex for mixture with the carbon black slurry may for example be natural rubber latex, synthetic rubber latex, and/or the like. It is preferred that the solids concentration of the rubber latex for mixture with the carbon black slurry be greater than the solids concentration of the rubber latex at the operation in which the carbon black slurry is made. It is preferred that the solids concentration of the rubber latex for mixture with the carbon black slurry be not less than 10 mass %, and more preferred that this be not less than 20 mass %. The upper limit of the range in values for the solids concentration at the rubber latex might, for example, be 60 mass %, it being preferred that this be 40 mass %, and it being more preferred that this be 35 mass %. While carbon black slurry and rubber latex refer to substances capable of being mixed using any known mixer, those in which blade(s) rotate within cylindrical vessel(s) may be favorably employed. The “Supermixer” manufactured by Kawata Co., Ltd., the “Supermixer” manufactured by Shinei-Kikai Co., Ltd., the “Universal Mixer” manufactured by Tsukishima Machine Sales Co., Ltd., and the “Henschel Mixer” manufactured by Nippon Coke & Engineering Co., Ltd., may be cited as examples.

In the pre-coagulation rubber latex, rubber particles, carbon black, and so forth are dispersed in water.

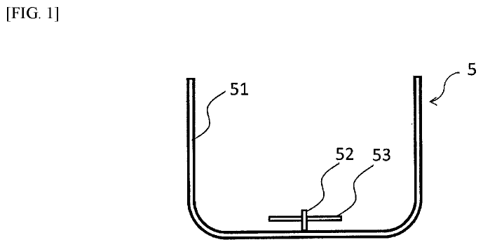

A masterbatch manufacturing method in accordance with the first embodiment comprises a first operation in which pre-coagulation rubber latex is heated as it is agitated with agitator 5 shown in FIG. 1. By carrying out heating as agitation takes place, it is possible to shorten agitation time as compared with the situation that exists when agitation is carried out without heating. Agitator 5 is equipped with agitation tank 51, rotating shaft 52 and agitator vane(s) 53. Rotating shaft 52 is provided at the bottom of agitation tank 51. It is preferred that rotating shaft 52 be parallel to the vertical. Agitator vane 53 is secured to rotating shaft 52. Besides agitator 5, it is also possible to employ a mixer, examples of which are the “Supermixer” manufactured by Kawata Co., Ltd., the “Supermixer” manufactured by Shinei-Kikai Co., Ltd., the “Universal Mixer” manufactured by Tsukishima Machine Sales Co., Ltd., and the “Henschel Mixer” manufactured by Nippon Coke & Engineering Co., Ltd.

The first operation satisfies Formula I. Because the first operation satisfies Formula I, a masterbatch manufacturing method in accordance with the first embodiment is capable of causing carbon black to be dispersed regardless of the particle diameter thereof.

b≥i×5.6/100 (FORMULA I)

b indicates the circumferential speed (m/s) of agitator vane 53. i indicates iodine absorption (g/kg) of carbon black. The circumferential speed of agitator vane 53 might, for example, be not less than 7 m/s, it being preferred that this be not less than 8 m/s, more preferred that this be not less than 10 m/s, and still more preferred that this be not less than 10.5 m/s. The upper limit of the range in values for the circumferential speed of agitator vane 53 might, for example, be 25 m/s.

The first operation furthermore satisfies Formula II. Because the first operation satisfies Formula II, a masterbatch manufacturing method in accordance with the first embodiment is capable of suppressing occurrence of a situation in which coagulant causes coagulation to occur while carbon black is still inadequately dispersed.

b×tₘ/eₕ×100>10 (FORMULA II)

tₘ indicates agitation time (s). eₕ is given by Formula III.

eₕ=(tₑ+tₛ)×tₘ/2 (FORMULA III)

tₑ indicates the temperature (° C.) of the pre-coagulation rubber latex at the end of the first operation. tₛ indicates the temperature (° C.) of the pre-coagulation rubber latex at the start of the first operation. b×tₘ at FORMULA II corresponds to the amount of rotation (m) of agitator vane 53. eₕ is the area of the trapezoid at the planar graph obtained by plotting agitation time on the horizontal axis and temperature of the pre-coagulation rubber latex on the vertical axis, and corresponds to the thermal energy input to the pre-coagulation rubber latex as a result of heating.

A masterbatch manufacturing method in accordance with the first embodiment further comprises a second operation in which, following the first operation, coagulant is added to the pre-coagulation rubber latex to obtain a coagulum. The coagulant might, for example, be an acid. As the acid, formic acid, sulfuric acid, and other such acids ordinarily used for coagulation of rubber latex may be cited as examples. The coagulum obtained by coagulation of the pre-coagulation rubber latex contains water.

A masterbatch manufacturing method in accordance with the first embodiment further comprises an operation the coagulum is dewatered, and is plasticized as it is dried.

A masterbatch manufacturing method in accordance with the first embodiment further comprises an operation in which the plasticized coagulum is molded as necessary to obtain masterbatch.

The masterbatch comprises rubber. The rubber might, for example, be natural rubber, isoprene rubber, butadiene rubber, styrene-butadiene rubber, nitrile rubber, chloroprene rubber, and/or the like. It is preferred that the amount of natural rubber in the masterbatch be not less than 70 mass %, more preferred that this be not less than 80 mass %, still more preferred that this be not less than 90 mass %, and still more preferred that this be 100 mass %, per 100 mass % of the rubber.

The masterbatch further comprises carbon black. For every 100 parts by mass of the rubber, it is preferred that the amount of carbon black be not less than 10 parts by mass, more preferred that this be not less than 20 parts by mass, and still more preferred that this be not less than 30 parts by mass. For every 100 parts by mass of the rubber, it is preferred that the amount of carbon black be not greater than 80 parts by mass, and more preferred that this be not greater than 60 parts by mass.

A tire manufacturing method in accordance with the first embodiment further comprises an operation in which masterbatch and compounding ingredient(s)—and, where necessary, rubber not originating from the masterbatch—are dry-blended in a mixer to obtain a mixture. The compounding ingredient(s) might, for example, be stearic acid, wax, zinc oxide, antioxidant, and/or the like. As examples of the antioxidant, aromatic-amine-type antioxidants, amine-ketone-type antioxidants, monophenol-type antioxidants, bisphenol-type antioxidants, polyphenol-type antioxidants, dithiocarbamate-type antioxidants, thiourea-type antioxidants, and the like may be cited. As rubber not originating from the masterbatch, natural rubber, isoprene rubber, butadiene rubber, styrene-butadiene rubber, nitrile rubber, chloroprene rubber, and the like may be cited as examples. As the mixer, internal mixers, open roll mills, and the like may be cited as examples. As an internal mixer, Banbury mixers, kneaders, and the like may be cited as examples.

A tire manufacturing method in accordance with the first embodiment further comprises an operation in which a vulcanizing-type compounding ingredient is added to the mixture, and in which the vulcanizing-type compounding ingredient is kneaded into the mixture to obtain a rubber composition. As examples of the vulcanizing-type compounding ingredient, sulfur, organic peroxides, and other such vulcanizing agents, vulcanization accelerators, vulcanization accelerator activators, vulcanization retarders, and so forth may be cited. As the sulfur, powdered sulfur, precipitated sulfur, insoluble sulfur, high dispersing sulfur, and the like may be cited as examples. As examples of the vulcanization accelerators, sulfenamide-type vulcanization accelerators, thiuram-type vulcanization accelerators, thiazole-type vulcanization accelerators, thiourea-type vulcanization accelerators, guanidine-type vulcanization accelerators, dithiocarbamate-type vulcanization accelerators, and so forth may be cited.

The rubber composition comprises a rubber component. As the rubber component, natural rubber, isoprene rubber, butadiene rubber, styrene-butadiene rubber, nitrile rubber, chloroprene rubber, and the like may be cited as examples. It is preferred that the amount of natural rubber be not less than 40 mass %, and more preferred that this be not less than 50 mass %, per 100 mass % of the rubber component. The upper limit of the range in values for the amount of natural rubber might, for example, be 100 mass %.

The rubber composition further comprises carbon black. For every 100 parts by mass of the rubber component, it is preferred that the amount of carbon black be not less than 10 parts by mass, more preferred that this be not less than 20 parts by mass, and still more preferred that this be not less than 30 parts by mass. For every 100 parts by mass of the rubber component, it is preferred that the amount of carbon black be not greater than 80 parts by mass, and more preferred that this be not greater than 60 parts by mass.

The rubber composition may further comprise stearic acid, wax, zinc oxide, antioxidant, sulfur, vulcanization accelerator, and/or the like. It is preferred that the amount of the sulfur, expressed as equivalent sulfur content, be 0.5 part by mass to 5 parts by mass for every 100 parts by mass of the rubber component. It is preferred that the amount of the vulcanization accelerator be 0.1 part by mass to 5 parts by mass for every 100 parts by mass of the rubber component.

The rubber composition may be employed in tread(s), sidewall(s), chafer(s), bead filler(s), and other such tire member(s).

A tire manufacturing method in accordance with the first embodiment comprises an operation in which a green tire equipped with a tire member made up of the rubber composition is made. The tire manufacturing method in accordance with the first embodiment further comprises an operation in which the green tire is heated. The tire obtained by the method of the first embodiment may be a pneumatic tire.

Variations on the first embodiment will now be described. Whereas the masterbatch manufacturing method in accordance with the first embodiment comprised an operation in which carbon black and rubber latex were mixed to obtain a carbon black slurry, a variation on the first embodiment comprises, instead of that operation, an operation in which carbon black and water are mixed to obtain a carbon black slurry.

### Working Examples

Working examples in accordance with the present disclosure are described below.

Raw materials and reagents are indicated below.
Natural rubber latex (dry rubber content=31.2%; Mw=232,000) Manufactured by Golden Hope
Coagulant Formic acid (reagent-grade 85%) manufactured by Nacalai Tesque, Inc. (diluted to obtain 10% solution and pH adjusted to 1.2 prior to use)
N110 carbon black “SEAST 9” manufactured by Tokai Carbon Co., Ltd.
N115 carbon black “SYNBLACK N115” manufactured by China Synthetic Rubber
N121 carbon black “SYNBLACK N121” manufactured by China Synthetic Rubber
N234 carbon black “SEAST 7 HM” manufactured by Tokai Carbon Co., Ltd.
Zinc oxide “Zinc Oxide No. 1” manufactured by Mitsui Mining & Smelting Co., Ltd.
Stearic acid “LUNAC S-20” manufactured by Kao Corporation
Wax “OZOACE 0355” manufactured by Nippon Seiro Co., Ltd.
Antioxidant A “6C” manufactured by Ouchi Shinko Chemical Industrial Co., Ltd.
Antioxidant B “RD” manufactured by Ouchi Shinko Chemical Industrial Co., Ltd.
Sulfur “Powdered Sulfur” manufactured by Tsurumi Chemical Industry Co., Ltd.
Vulcanization accelerator “Sanceler CM” manufactured by Sanshin Chemical Industry Co., Ltd.

Preparation of Masterbatch

Water was added at 25° C. to natural rubber latex manufactured by Golden Hope in an amount sufficient to adjust solids (rubber) concentration to 25 mass %. Carbon black was added to water, and an agitator manufactured by Silverson (Flashblend) was used to disperse the carbon black (Flashblend conditions: 3600 rpm; 30 min) to obtain a carbon black slurry. The carbon black slurry was added to the natural rubber latex having the solids (rubber) concentration that was 25 mass % in accordance with TABLE 1, a mixer (SM-20 Supermixer) manufactured by Kawata Co., Ltd., was used to carry out agitation under the conditions listed at TABLE 1, and coagulant was thereafter added in an amount sufficient to achieve a pH of 3 to 4 to obtain a coagulum. The coagulum was placed in a squeezer-type single-screw dewatering extruder (Model V-02 screw press manufactured by Suehiro EPM Corporation), dewatering was carried out, and plasticization was carried out as this was dried, to obtain a masterbatch.

Preparation of Unvulcanized Rubber

The compounding ingredients except for sulfur and vulcanization accelerator were added to the masterbatch in accordance with TABLE 1, a Model B Banbury mixer manufactured by Kobe Steel, Ltd., was used to carry out kneading, and the rubber mixture was discharged. The rubber mixture was then kneaded together with sulfur and vulcanization accelerator in a Model B Banbury mixer to obtain unvulcanized rubber.

Nonuniformity of Carbon Black in Masterbatch

A thermogravimetric/differential thermal analytic apparatus TG/DTA was used to evaluate the amount (parts by mass) of carbon black per 100 parts by mass of rubber component within the masterbatch. More specifically, N=3 samples were chosen at random from the masterbatch, the amount (parts by mass) of carbon black was determined for each specimen, and the difference between the median value and the amount of carbon black that was farthest from the median value was determined, a difference that was less than 1 part by mass being evaluated as GOOD, a difference that was greater than or equal to 1 part by mass but that was less than 2 parts by mass being evaluated as FAIR, and a difference that was greater than or equal to 2 parts by mass being evaluated as BAD.

Heat Generation

Unvulcanized rubber was vulcanized at 150° C. for 30 min, and the heat generation of the vulcanized rubber was evaluated based on the loss tangent tan δ thereof tan δ was determined in accordance with JIS K-6265 based on testing performed using an E4000 rheospectrometer manufactured by UBM at 50 Hz, 80° C., and a dynamic strain of 2%. tan δ of the respective Examples are shown as indexed relative to a value of 100 for the tan δ obtained at Comparative Example 1. The lower the index the lower—and thus the better—was the heat generation.

Fatigue Resistance

Fatigue resistance of the vulcanized rubber was evaluated in accordance with JIS K-6260. Results obtained at the various Examples are shown as indexed relative to a value of 100 for the result obtained at Comparative Example 1. The higher the index the better it was in terms of fatigue resistance.

TABLE 1

| | | | Comparative | Comparative | Comparative | Working | Working |
|---|---|---|---|---|---|---|---|
| | | | Example 1 | Example 2 | Example 3 | Example 1 | Example 2 |
| Amount blended | Masterbatch | N110 carbon black | 45 | 45 | 45 | 45 | 45 |
| therein | | N115 carbon black | — | — | — | — | — |
| (parts by mass) | | N121 carbon black | — | — | — | — | — |
| | | N234 carbon black | — | — | — | — | — |
| | | Natural rubber | 100 | 100 | 100 | 100 | 100 |
| | | (solids content) | | | | | |
| | Unvulcanized | Masterbatch | 145 | 145 | 145 | 145 | 145 |
| | rubber | Zinc oxide | 3 | 3 | 3 | 3 | 3 |
| | | Stearic acid | 2 | 2 | 2 | 2 | 2 |
| | | Wax | 1 | 1 | 1 | 1 | 1 |
| | | Antioxidant A | 2 | 2 | 2 | 2 | 2 |
| | | Antioxidant B | 1 | 1 | 1 | 1 | 1 |
| | | Sulfur | 2 | 2 | 2 | 2 | 2 |
| | | Vulcanization | 1 | 1 | 1 | 1 | 1 |
| | | accelerator | | | | | |

| First operation | b (agitator vane circumferential speed m/s) | 6.1 | 8.5 | 6.1 | 8.5 | 11.5 |
|---|---|---|---|---|---|---|
| | eₕ (thermal energy) | 71400 | 107400 | 83400 | 83400 | 83400 |
| | b × tₘ (amount of rotation) | 7379 | 10146 | 7379 | 10146 | 13836 |
| | i (iodine absorption g/kg) | 145 | 145 | 145 | 145 | 145 |
| | i × 5.6/100 | 8.1 | 8.1 | 8.1 | 8.1 | 8.1 |
| | b × tₘ/eₕ × 100 | 10 | 9 | 9 | 12 | 17 |
| Nonuniformity of carbon black in masterbatch | | FAIR | FAIR | BAD | GOOD | GOOD |
| Vulcanized rubber | Heat generation (relative to index value) | 100 | 106 | 103 | 92 | 88 |
| | Fatigue resistance (relative to index value) | 100 | 93 | 97 | 108 | 112 |

| | | | Working | Working | Working | Working | Working |
|---|---|---|---|---|---|---|---|
| | | | Example 3 | Example 4 | Example 5 | Example 6 | Example 7 |
| Amount blended | Masterbatch | N110 carbon black | 45 | 45 | — | — | — |
| therein | | N115 carbon black | — | — | 45 | — | — |
| (parts by mass) | | N121 carbon black | — | — | — | 45 | — |
| | | N234 carbon black | — | — | — | — | 45 |
| | | Natural rubber | 100 | 100 | 100 | 100 | 100 |
| | | (solids content) | | | | | |
| | Unvulcanized | Masterbatch | 145 | 145 | 145 | 145 | 145 |
| | rubber | Zinc oxide | 3 | 3 | 3 | 3 | 3 |
| | | Stearic acid | 2 | 2 | 2 | 2 | 2 |
| | | Wax | 1 | 1 | 1 | 1 | 1 |
| | | Antioxidant A | 2 | 2 | 2 | 2 | 2 |
| | | Antioxidant B | 1 | 1 | 1 | 1 | 1 |
| | | Sulfur | 2 | 2 | 2 | 2 | 2 |
| | | Vulcanization | 1 | 1 | 1 | 1 | 1 |
| | | accelerator | | | | | |

| First operation | b (agitator vane circumferential speed m/s) | 15.4 | 8.5 | 9.2 | 8.5 | 8.5 |
|---|---|---|---|---|---|---|
| | eₕ (thermal energy) | 83400 | 71400 | 83400 | 83400 | 83400 |
| | b × tₘ (amount of rotation) | 18447 | 10146 | 11068 | 10146 | 10146 |
| | i (iodine absorption g/kg) | 145 | 145 | 160 | 121 | 120 |
| | i × 5.6/100 | 8.1 | 8.1 | 9.0 | 6.8 | 6.7 |
| | b × tₘ/eₕ × 100 | 22 | 14 | 13 | 12 | 12 |
| Nonuniformity of carbon black in masterbatch | | GOOD | GOOD | GOOD | GOOD | GOOD |
| Vulcanized rubber | Heat generation (relative to index value) | 90 | 89 | 96 | 85 | 81 |
| | Fatigue resistance (relative to index value) | 112 | 114 | 109 | 115 | 117 |

Causing agitation to take place in such fashion as to satisfy Formula I and Formula II made it possible to prepare a masterbatch having excellent fatigue resistance and/or heat generation in vulcanized rubber. For example, as compared with Comparative Example 1, Working Example 1 showed an improvement of 8 points in terms of reduced heat generation, and showed an improvement of 8 points in terms of fatigue resistance.

1. A masterbatch manufacturing method comprising:
a first operation in which a pre-coagulation rubber latex comprising carbon black is heated as it is agitated with an agitator provided with an agitator vane; and
a second operation in which coagulant is added to the pre-coagulation rubber latex;
wherein the first operation satisfies Formula I and Formula II;
wherein the Formula I is
b≥i×5.6/100;
wherein the Formula II is
b×tₘ/eₕ×100>10;
wherein b indicates circumferential speed (m/s) of the agitator vane;
wherein i indicates iodine absorption (g/kg) of the carbon black;
wherein tₘ indicates agitation time (s);
wherein eₕ is given by Formula III;
wherein the Formula III is
eₕ=(tₑ+tₛ)×tₘ/2;
wherein tₑ indicates temperature (° C.) of the pre-coagulation rubber latex at an end of the first operation; and
wherein tₛ indicates temperature (° C.) of the pre-coagulation rubber latex at a start of the first operation.

2. The masterbatch manufacturing method according to claim 1 wherein iodine absorption of the carbon black is not less than 100 g/kg.

3. A rubber composition manufacturing method comprising:
an operation in which the masterbatch manufacturing method according to claim 1 is used to prepare a masterbatch;
an operation in which at least the masterbatch and compounding ingredients are dry-mixed to obtain a mixture; and
an operation in which at least a vulcanizing-type compounding ingredient is kneaded into the mixture.

4. A tire manufacturing method comprising:
an operation in which the masterbatch manufacturing method according to claim 1 is used to prepare a masterbatch;
an operation in which at least the masterbatch and compounding ingredients are dry-mixed to obtain a mixture;
an operation in which at least a vulcanizing-type compounding ingredient is kneaded into the mixture to obtain a rubber composition; and
an operation in which a green tire equipped with a tire member made up of the rubber composition is made.

5. The masterbatch manufacturing method according to claim 1 wherein iodine absorption of the carbon black is 100 g/kg to 170 g/kg.

6. The masterbatch manufacturing method according to claim 1 wherein iodine absorption of the carbon black is 100 g/kg to 160 g/kg.

7. The masterbatch manufacturing method according to claim 1 wherein circumferential speed of the agitator vane at the first operation is not less than 7 m/s.

8. The masterbatch manufacturing method according to claim 1 wherein circumferential speed of the agitator vane at the first operation is 7 m/s to 25 m/s.

9. The masterbatch manufacturing method according to claim 1 further comprising an operation in which rubber latex and a carbon black slurry comprising the carbon black are mixed to obtain the pre-coagulation rubber latex.

10. The masterbatch manufacturing method according to claim 9 wherein the carbon black is present in the carbon black slurry in an amount that is 1 mass % to 15 mass % per 100 mass % of the carbon black slurry.

11. The masterbatch manufacturing method according to claim 9 wherein the rubber latex is natural rubber latex.

12. The masterbatch manufacturing method according to claim 9 wherein solids concentration of the rubber latex is 10 mass % to 60 mass %.
